(19) United States
(12) Patent Application Publication
(10) Pub. No.: US 2002/0114917 A1
(43) Pub. Date: Aug. 22, 2002

(54) Methods of coloring solution-dyed nylon

(76) Inventors: Seiin Kobayashi, Yonezawa-shi (JP); Yoshikatsu Sugata, Yonezawa-shi (JP)

Correspondence Address: Milliken & Company, P. O. Box 1927, Spartanburg, SC, 29304, US

(21) Appl. No.: 10/078,590

(22) Filed: Feb. 19, 2002

Related U.S. Application Data
(62) Division of application No. 09/437,163, filed on Nov. 10, 1999.
Application No. 09/437,163 is a division of application No. 09/335,197, filed on Jun. 17, 1999.

(30) Foreign Application Priority Data
Oct. 29, 1999 (JP) 309443/99

(51) Int. Cl. B32B 3/02

(52) U.S. Cl. 428/85

(57) ABSTRACT

This invention relates to new dyeing systems for nylon pile fabrics which are free from chrome-metallized dyestuffs and which comprise at least one cobalt-metallized dyestuff and at least one milling acid dyestuff. Such systems provide highly desirable and effective colorations within target pile fabrics and also provide dramatic mprovements in bleach resistance to the nylon fabric surface. The inventive colored pile fabrics are utilized generally as components within launderable floor mat articles which require periodic cleaning with bleach-containing formulations. Thus, the inventive colored fabrics do not exhibit any appreciable reduction in color after such continuous, periodic rigorous cleaning procedures. Floor mats comprised of such inventive colored pile fabrics as well as the particular dyestuff compositions themselves are also encompassed within this invention. Furthermore, methods of coloring pile fabrics with dyestuffs including a heated topical overspray treatment to provide improvements in lightfastness and washfastness are also included.

### CROSS REFERENCE TO RELATED APPLICATIONS

This application is a divisional of co-pending application Ser. No. 09/335,197, filed on Jun. 17, 1999.

### FIELD OF THE INVENTION

This invention relates to new dyeing systems for nylon pile fabrics which are free from chrome-metallized dyestuffs and which comprise at least one cobalt-metallized dyestuff and at least one milling acid dyestuff. Such systems provide highly desirable and effective colorations within target pile fabrics and also provide dramatic improvements in bleach resistance to the nylon fabric surface. The inventive colored pile fabrics are utilized generally as components within launderable floor mat articles which require periodic cleaning with bleach-containing formulations. Thus, the inventive colored fabrics do not exhibit any appreciable reduction in color after such continuous, periodic rigorous cleaning procedures. Floor mats comprised of such inventive colored pile fabrics as well as the particular dyestuff compositions themselves are also encompassed within this invention. Furthermore, methods of coloring pile fabrics with dyestuffs including a heated topical overspray treatment to provide improvements in lightfastness and washfastness are also included.

### BACKGROUND OF THE INVENTION

All U.S. patents listed below are herein incorporated by reference.

Pile fabrics, in particular tufted fabrics, have been utilized for many years within various applications, most notably within floor coverings. One particular type of floor covering product which comprises pile fabrics is a carpeted floor mat. Floor mats have long been utilized to facilitate the cleaning of the bottoms of people's shoes, particularly in areas of high pedestrian traffic such as doorways. Moisture, dirt, and debris from out of doors easily adhere to such footwear, particularly in inclement weather and particularly in areas of grass or mud or the like. Such unwanted and potentially floor staining or dirtying articles need to be removed from a person's footwear prior to entry indoors. As will be appreciated, such outdoor mats by their nature must undergo frequent repeated washings and dryings so as to remove the dirt and debris deposited thereon during use. Furthermore, such cleaning procedures generally include the exposure of the soiled pile fabrics to bleach formulations in order to throughly remove such dirt and debris and possibly kill any unwanted and potentially harmful microorganisms from the floor mat surface. Generally, such floor mats rented from service entities which retrieve the soiled mats from the user and provide clean replacement mats on a frequent basis. The soiled mats are thereafter cleaned and dried in an industrial laundering process (such as within rotary washing and drying machines, for example) and then sent to another user in replacement of newly soiled mats.

Floor and/or dust control mats have been developed in the past which provide an easy manner of cleaning the soles of a person's shoes simply by scraping the footwear against such a stiff article. Examples of such floor mats or carpet piles are exemplified in U.S. Pat. No. 1,008,618, to Skowronski et al.; U.S. Pat. No. 4,045,605, to Breens et al.; U.S. Pat. No. 3,306,808, to Thompson, et al.; U.S. Pat. No. 4,353,944, to Tarui; U.S. Pat. No. 4,741,065, to Parkins; U.S. Pat. No. 4,886,692, to Kerr et al.; U.S. Pat. No. 5,227,214, to Kerr et al.; U.S. Pat. No. 5,305,565, to Nagahama et al.; U.S. Pat. No. 5,350,478, to Bojstrup et al.; and U.S. Pat. No. 5,680,826, to Nagahama et al.; as well as French Patent No. 1,211,755, assigned to Cosyntex (S.A.) and PCT Application 95/30040, assigned to Kleen-Tex Industries, Inc., all of which are incorporated herein by reference. Nowhere in the prior art is an industrially launderable floor mat comprised of Further examples of such floor mat articles are taught within U.S. Pat. No. 5,707,469 to Hixson et al., U.S. Pat. No. 5,645,914 to Horowitz, and U.S. Pat. No. 4,741,065 to Parkins.

As will be appreciated by the ordinarily skilled artisan, such pile fabrics may be colored and/or patterned with dyestuffs to provide aesthetically pleasing products for placement in certain locations around entryways, around produce refrigerators and freezers in grocery stores, and the like. Since such colored pile fabrics must be subjected to harsh cleaning procedures, both physically and chemically, the dyestuffs utilized to provide such desired colorations must be able to withstand bleach exposure as well as vigorous rotary washings and dryings on an industrial level.

In order to provide consumers with aesthetically pleasing floor covering products which also exhibit beneficial bleach-resistance, metal-containing dyestuffs have been utilized to color such pile fabrics in uniform shades or patterns. Chrome-metallized dyestuffs have constituted one of the most prevalent classes of dyestuffs utilized within pile fabric coloring processes. These dyestuffs have historically provided such excellent colorations and beneficial bleach-resistance to the target pile fabric substrates. Such chrome-metallized compounds, however, have lost favor recently as pile fabric dyestuffs due to safety issues with their use on an industrial level. In particular, chromium (VI) metal-containing dyestuffs have been banned in Europe. Furthermore, the use of all chromium-containing dyestuffs has been discontinued in Japan. Although such harmful effects are not caused as prevalently by chromium-containing dyestuffs of different valences [such as chromium (III), for example], the removal of all chrome-metallized dyestuffs from pile fabric coloring procedures has been followed recently in response to the new information concerning the danger involved with the utilization of chromium (VI)-containing dyestuffs. Thus, there has been a recognized need for the replacement of such potentially dangerous colorants with other, relatively safe non-chromium-metallized dyestuffs, within such coloring processes. To date, this problem has not been addressed within the pile fabric art, particularly not within the floor mat product art. Thus, the prior art has no accorded the floor mat rental laundry industry with any teaching or fair suggestion providing any basis for replacement of such well-performing chrome-metallized dyestuffs.

### OBJECTS AND DESCRIPTION OF THE INVENTION

It is thus an object of this invention to provide a highly bleach-resistant, colored pile fabric. Another object of this invention is to provide a floor mat product including a colored pile fabric which exhibits excellent coloring without the need for chrome-metallized dyestuffs. A further object of this invention is to provide a floor mat product including a colored pile fabric which can be laundered periodically with bleach compositions and which do not lose an appreciable amount of color due to such exposure to bleach-containing cleaning formulations.

Accordingly, this invention encompasses a pile fabric comprising synthetic fibers (preferably nylon, and more preferably solution-dyed nylon) wherein at least a portion of said synthetic fibers is colored with at least two different dyestuffs, a first dyestuff selected from the group consisting of at least one cobalt-metallized dyestuff and a second dyestuff selected from the group consisting of at least one milling acid dyestuff; and wherein said synthetic fibers are not colored with any chrome-metallized dyestuffs. The invention also encompasses a floor mat product comprising such a pile fabric. Such a specific combination of dyestuffs provides excellent durable colorations, washfastness, weatherfastness, and bleach-resistance to the target pile fabric.

The synthetic fibers of the inventive pile fabric thus may be any fiber of manmade origin. Such fibers may be thus be selected from, without limitation, polyester, polyamide (nylon, such as nylon-6, or nylon-6,6, which is preferred), polypropylene, fiberglass, and the like, as well as blends of such fibers. The fibers may be coarse or fine in structure as well. The denier of such individual fibers may range from about 10 to about 200; preferably, such fibers possess deniers ranging from about 20 about 100, more preferably from about 20 to about 25, and most preferably at about 23. A plurality of such fibers may preferably be twisted together to form yarns (preferably between about 40 and 80 are twisted in such a manner, most preferably about 60), and then multiple plies of such yarns (3, as one preferred example) may also be twisted together to form the final yarn structures to be incorporated within the target pile fabrics. Of particular interest in this invention, as noted above, are 100% solution dyed nylon fibers. Such pile fibers provide the best pile surface for overprinting with different dyes in order to provide the most aesthetically pleasing colorations and shades on the floor mat pile surface. Such fibers are generally nylon-6,6 in structure and possess deniers in the range from about 10 to about 30, from 20 to about 25 preferred, which are twisted together (about 60, for example) in 3-ply structures. The preferred solution-dyed nylon fibers are available, as merely one example, from Camac. Such fibers have been colored in the past with a variety of different dyestuffs; however, there is no teaching or fair suggestion regarding the utilization of the particular mixture of cobalt-metallized and milling acid dyestuffs of this invention.

Cobalt-metallized dyestuffs have been utilized extensively for coloring different fibers, most notably polyamides, in the past. For example, U.S. Pat. No. 3,658,460 to Mikula, U.S. Pat. No. 3,221,004 to Neier, and U.S. Pat. No. 2,374,106 to Kvalnes et al. all discuss such coloring procedures. The term “cobalt-metallized” is intended to encompass any class of dyestuffs comprising water-solubilizing groups (such as carboxylic acid, sulfonic acid, sulfonoamido, etc., groups) and which also comprise cobalt metal ions complexed with standard dye components (such as azos, disazos, methines, bisazos, and the like). Thus, as merely examples, azo compounds complexed with cobalt metals and which also comprise at least one water-solubilizing group are encompassed within the term cobalt-metallized dyestuffs. Specific types of cobalt-metallized dyesuffs which may be utilized within this invention include, without limitation, Isolan® Bordeaux R 220 (from DyStar), Kayakalan™ Brown GL (from Nippon Kayaku), and Irgalan® Yellow 3RL 250% (from Ciba). As will be fully understood and appreciated by one of ordinary skill in this art, any combinations of such dyestuffs may be produced in order to provide different shades or hues on the target pile fabrics. Such dyestuffs generally provide excellent weather fastness to the target pile fabrics as well as excellent colorations (with blue, red, yellow, green, gray, and the like, hues and shades available). Since most carpeted (i.e., including a pile fabric component) floor mat articles are placed at exteriors of entryways, exposure to outdoor environment is a major concern for such articles. Thus, these dyestuffs provide such desirable characteristics. Milling acid dyestuffs have been utilized for coloring other types of fibers, such as wool (U.S. Pat. No. 4,436,521 to Annen et al., for example). Such a term as “milling acid” basically encompasses dyestuffs which comprise acid groups (such as sulfonic, carboxylic, phthalic acid groups, and the like) and which do not comprise metal constituents anywhere on the dyestuff. Such a term is standard as will be appreciated by the ordinarily skilled artisan in the dyestuff art. (These are very similar to metallized dyestuffs but do not comprise such metals, as noted above). However, there is no teaching of the combination of such dyestuffs within compositions or processes for the coloring of pile fabrics. Such dyestuffs have been found to provide the desirable bleach resistance required of the inventive pile fabrics, particularly those to be incorporated within floor mat articles that must undergo rigorous and periodic industrial cleaning procedures (which will include bleach exposure). Specific types of milling acid dyestuffs which may be utilized in this invention include, without limitation, Aminyl Rubine FD-BL™ (from Sumitomo), Supranol® Fast Blue GN 167% (from DyStar), and Supranol® Orange GSN (from DyStar). Any milling acid may be utilized, however, and this list is not meant to be exhaustive.

Compositions comprising both of these types of dyestuffs may be applied in any manner to the target pile fibers. Examples of such available coloring procedures includes, jet dyeing, spraying, immersing, brushing, and the like. Spray techniques are most preferred including processes that utilize a plurality of individual jet nozzles for patterning capability as well as thorough coloring of each individual target fiber. Such spraying techniques include the utilization of Millitron® and Chromojet® dyeing machines.

The lightfastness and washfastness of such inventive pile fabrics have been found to be at acceptable levels through the sole utilization of the aforementioned cobalt-metallized and milling acid dyestuffs. However, improvements in these two benefits are available upon the use of a topical overspray, as merely one example, applied after printing of the target pile fibers with the desired dyestuff compositions, steamed (to set the colorations within the pile fabric), and washed of excess dyestuff. In general, the topical overspray should comprise a polymeric finishing agent to coat the pile fabric (or, actually, the individual pile fibers) in order to protect the same from environmental and atmospheric exposure and potential damage. One specific topical overspray includes Sunlife® EPS-2, manufactured by Emori Shoji which comprises an anionic polymer finish. The aqueous form of such a topical overspray possesses a pH of roughly 2.0 (in 2% concentration). This is due in large part to the presence of relatively large amounts of organic acid (i.e., acetic acid) within such a composition. Generally, it has been found that differing concentrations of such a topical overspray provide beneficial finishing coats (levels of protection) for different dyestuff systems. Furthermore, it has been suprisingly found that of particular importance with such an overspray application is heating such a composition to about at least 70° C., preferably above about 85° C. Such an elevated temperature provides the desired increase in washfastness and lightfastness for the inventive pile fabrics over not only the absence of such an overspray, but also over an overspray which is first heated to ambient temperature or, at least, at a temperature lower than about 70° C., and then added to the inventive pile fabric. Nowhere within the prior art is such a heated overspray composition step taught or even fairly suggested for beneficial improvements in pile fabric color protection from environmental and/or atmospheric exposure.

The inventive pile fabrics have thus been colored with a specific combination of dyestuffs and, optionally, treated with a heated topical overspray. It has now been determined that pleasing textures and shades are possible through the utilization of cobalt-metallized dyestuffs while such pleasant colorations are not compromised through the introduction of at least one additional milling acid dyestuff which provides the beneficial bleach-resistance properties to the finished product. Such a finding required extensive review of many different types of metallized dyestuffs (other than chromium-based compounds, of course). Even with proper colorations, the selected dyestuffs had to provide bleach-resistance in order to be utilized as possible replacements for the aforementioned chromium-metallized dyestuffs. It was determined that bleach-resistance was not completely obtainable through the sole utilization of other metallized dyestuffs; additional ingredients were required within the inventive dyestuff formulation to provide such a necessary benefit. After further extensive testing, it was realized that milling acid dyes provided such desired and required bleach-resistance without deleteriously affecting the colorations provided by the cobalt-metallized compounds. Such a combination, as noted above, is neither taught nor fairly suggested within the prior art.

The inventive floor mat article generally comprises any amount of the inventive colored pile fabric. Other types of fibers, such as cotton, wool, and the like, may be present within the inventive floor mat, as well as non-colored synthetic fibers. The key component of this inventive floor mat is the presence of at least a portion of the inventive colored pile fabric. Such pile fabrics, both the inventive and standard types, within the inventive floor mat are generally tufted through a pile substrate prior to incorporation within the floor mat article itself. Any type of standard pile substrate may be utilized, including woven, non-woven, and knit forms. The pile substrate may comprise wither synthetic or natural fibers, including, as merely examples, polyester, polyamide, cotton, sisal, wool, and the like.

In general, such floor mat articles also include rubber backing sheets. The carpet fibers, tufted through the pile substrate, are placed on top of such a backing sheet and the entire composite is then subjected to high vulcanization temperatures and pressures (i.e., pressures of from about 25 to about 40 psi at a temperature of from about 300 to about 400° F. for anywhere between about 30 seconds and 20 minutes). The substrate and pile fabric become attached to the rubber backing sheet during such a vulcanization procedure. U.S. Pat. No. 5,585,565, to Nagahama et al., previously entirely incorporated by reference, shows the usual manner of producing floor mats comprising carpet pile fibers, a carpet pile substrate, and a rubber backing sheet. This reference, however, makes no mention as to the importance of coloring pile fabrics with specific metallized and milling acid dyes to provide excellent alternatives to chromium-metallized dyestuffs. It is further noted that the inventive combination of dyestuffs for such pile fabrics must also be able to withstand such elevated temperatures and pressures. This selection criteria was also met by the cobalt-metallized and milling acid dyestuffs applied to the target pile fabrics.

As noted previously, this invention concerns, in its broadest sense, pile fabrics colored with compositions of cobalt-metallized and milling acid dyestuffs; these pile fabrics may therefore be incorporated within or utilized as carpets, rugs, mats, wall-coverings, automobile interiors, and the like.

### DETAILED DESCRIPTION OF THE PREFERRED EMBODIMENT

Without limiting the scope of the invention, the preferred features of the invention are exemplified below.

### EXAMPLE 1

An undyed pile fabric comprising very fine three-ply solution-dyed nylon fibers, with each individual fiber possessing a denier of about 23, each yarn containing about 60 twisted fibers (thus having a denier of about 1380), and each three-ply structure of yarns having a denier of about 4140, was placed within a Millitron®-brandjet-dyeing machine. The fabric was then dyed a red pattern, with discrete black spots interpersed therein. The colorant composition sprayed onto the fabric surface comprised the following (each in aqueous solution):

TABLE 1

| Dyestuff | Concentration (g/L) |
|---|---|
| Isolan ® Bordeaux R 220 | 0.5200 |
| Supranol ® Orange GSN | 2.0000 |
| Kayakalan ® Brown GL | 0.7280 |
| Water | Balance |

A thickening agent (Kelzan S) was added to modify the viscosity of the composition to about 450 cps. The colored pile fabric exhibited an excellent thorough red color throughout. The colored fabric was then laundered utilizing standard industrial-style rotary washing and drying machines, including cleaning compositions comprising chlorine bleach constituents. The pile fabric did not exhibit any appreciable loss of color upon 10 such repeated laundering procedures. Also, the pile fabric was then placed on top of a rubber sheet and subsequently subjected to a vulcanization procedure for about 15 minutes. The color was not appreciably affected by such high temperatures and pressures. Lastly, the pile fabric-containing (inventive) floor mat article was placed outside an entryway for 4 weeks to test for performance as a floor mat article. After another laundering as noted above, the floor mat article did not exhibit any appreciable difference in color shade or color strength empirically. This floor mat article pile fabric was also compared with a standard chrome-metallized red-colored pile fabric incorporated within a similar floor mat article. Through the utilization of a gray scale (empirical test) after bleaching and after exposure to a xenon-arc Weatherometer apparatus, all of the bleachfastness and weatherability (lightfastness) characteristics of the inventive fabric either met or exceeded that of the comparative chrome-metallized colored fabric.

### EXAMPLE 2

An undyed pile fabric comprising very fine three-ply solution-dyed nylon fibers, with each individual fiber possessing a denier of about 23, each yarn containing about 60 twisted fibers (thus having a denier of about 1380), and each three-ply structure of yarns having a denier of about 4140, was placed within a Millitron®-brand jet-dyeing machine. The fabric was then dyed a green pattern, with discrete black spots interpersed therein. The colorant composition sprayed onto the fabric surface comprised the following (each in aqueous solution):

TABLE 2

| Dyestuff | Concentration (g/L) |
|---|---|
| Isolan ® Bordeaux R 220 | 0.6540 |
| Supranol ® Fast Blue GN | 2.7380 |
| Irgalan ® Yellow 3RL | 0.0196 |
| Aminyl Rubine ™ FD-BL | 0.6540 |
| Water | Balance |

A thickening agent (Kelzan S) was added to modify the viscosity of the composition to about 450 cps. The colored pile fabric exhibited an excellent thorough green color throughout. The colored fabric was then laundered utilizing standard industrial-style rotary washing and drying machines, including cleaning compositions comprising chlorine bleach constituents. The pile fabric did not exhibit any appreciable loss of color upon 10 such repeated laundering procedures. Also, the pile fabric was then placed on top of a rubber sheet and subsequently subjected to a vulcanization procedure for about 15 minutes. The color was not appreciably affected by such high temperatures and pressures. Lastly, the pile fabric-containing (inventive) floor mat article was placed outside an entryway for 4 weeks to test for performance as a floor mat article. After another laundering as noted above, the floor mat article did not exhibit any appreciable difference in color shade or color strength empirically. This floor mat article pile fabric was also compared with a standard chrome-metallized red-colored pile fabric incorporated within a similar floor mat article. Through the utilization of a gray scale (empirical test) after bleaching and after exposure to a xenon-arc Weatherometer apparatus, all of the bleachfastness and weatherability (lightfastness) characteristics of the inventive fabric either met or exceeded that of the comparative chrome-metallized colored fabric.

### EXAMPLE 3

An undyed pile fabric comprising all solution-dyed nylon fibers possessing deniers of between about 20 to 25 was placed within a Millitron®-brand jet-dyeing machine. The fabric was then dyed a red pattern, with discrete black spots interpersed therein, with the same composition as in TABLE 1, above. The pile fabric exhibited an excellent thorough red color throughout. The colored fabric was then steamed (with water vapor heated to a temperature above about 212° C.) and subsequently washed with water to remove any excess dyestuff remaining on the surface of the fabric. Then, the pile fabric was completely sprayed with a composition of Sunlife® EPS-2 which had been heated to a temperature of about 85° C. and allowed to dry. The treated pile fabric was then laundered utilizing standard industrial-style rotary washing and drying machines, including cleaning compositions comprising chlorine bleach constituents. The pile fabric did not exhibit any appreciable loss of color upon 10 such repeated laundering procedures. Also, the pile fabric was then placed on top of a rubber sheet and subsequently subjected to a vulcanization procedure for about 15 minutes. The color was not appreciably affected by such high temperatures and pressures. Lastly, the pile fabric-containing (inventive) floor mat article was placed outside an entryway for 4 weeks to test for performance as a floor mat article. After another laundering as noted above, the floor mat article did not exhibit any appreciable difference in color shade or color strength empirically. This floor mat article pile fabric was also compared with a standard chrome-metallized red-colored pile fabric incorporated within a similar floor mat article. Through the utilization of a gray scale (empirical test) after bleaching and after exposure to a xenon-arc Weatherometer apparatus, all of the bleachfastness and weatherability (lightfastness) characteristics of the inventive fabric either met or exceeded that of the comparative chrome-metallized colored fabric.

While specific features of the invention have been described, it will be understood, of course, that the invention is not limited to any particular configuration or practice since modification may well be made and other embodiments of the principals of the invention will no doubt occur to those skilled in the art to which the invention pertains. Therefore, it is contemplated by the appended claims to cover any such modifications as incorporate the features of the invention within the true meaning, spirit, and scope of such claims.

What is claimed is:

7. A method of coloring synthetic pile fibers incorporated within pile fabrics, said method comprising the steps of
(a) providing said synthetic pile fibers;
(b) coloring said synthetic pile fibers with a composition comprising at least one cobalt-metallized dyestuff and at least one milling acid dyestuff;
(c) optionally, steaming said colored pile fibers;
(d) optionally, washing any excess dyestuff from said pile fibers;
(e) optionally, providing a topical overspray composition heated to at least 70° C.; and
(f) optionally, applying said topical overspray composition of step “e” to said colored pile fibers.

2. The method of claim 1 wherein said synthetic pile fibers are comprised of nylon fibers and wherein steps “c” through “e” are present.

3. The method of claim 2 wherein said nylon fibers are solution-dyed nylon fibers.

4. A method of coloring pile fibers incorporated within pile fabrics, said method comprising the steps of
(a) providing said pile fibers;
(b) coloring said synthetic pile fibers with a composition comprising at least one dyestuff;
(c) steaming said colored pile fibers;
(d) washing any excess dyestuff from said pile fibers;
(e) providing a topical overspray composition heated to at least 70° C.; and
(f) applying said topical overspray composition of step “e” to said colored pile fibers.
